(19) United States
(12) Patent Application Publication
(10) Pub. No.: US 2025/0234296 A1
(43) Pub. Date: Jul. 17, 2025

(54) COMMUNICATION DEVICE

(71) Applicant: COMPAL ELECTRONICS, INC., Taipei City (TW)

(72) Inventors: Chao-Yu Wu, Taipei City (TW); Chung-Miao Hsu, Taipei City (TW); Wang-Hung Yeh, Taipei City (TW)

(73) Assignee: COMPAL ELECTRONICS, INC., Taipei City (TW)

(21) Appl. No.: 19/017,759

(22) Filed: Jan. 12, 2025

Related U.S. Application Data
(60) Provisional application No. 63/621,107, filed on Jan. 16, 2024.

(51) Int. Cl. H04W 52/02; H04M 1/02; H04M 1/18

(52) U.S. Cl. CPC H04W 52/0254; H04M 1/0203; H04M 1/18

(57) ABSTRACT

A communication device includes a device body and a knob. The device body has a through hole. The knob is rotatably installed in the through hole, and a back side of the knob is exposed to the device body through the through hole and has a positioning hole. The knob is adapted to rotate to a first state with respect to the device body so that the communication device is in a startup mode, and the knob is adapted to rotate to a second state with respect to the device body so that the communication device is in a shutdown mode. The device provides a technical effect of switching operation modes quickly.

### CROSS-REFERENCE TO RELATED APPLICATION

This application claims the priority benefits of U.S. provisional application Ser. No. 63/621,107, filed on Jan. 16, 2024. The entirety of the above-mentioned patent application is hereby incorporated by reference herein and made a part of this specification.

### BACKGROUND

### Technical Field

The disclosure relates to an electronic device, and in particular to a communication device.

### Description of Related Art

Satellite communicators are safety equipment for outdoor activities such as mountain climbing, and are used to provide users with remote communication capabilities when mobile phone reception is poor or interrupted. In the existing technology, switching the satellite communicator on and off is relatively cumbersome and easily consumes the precious battery power. In addition, the switches of the existing satellite communicators lack a waterproof mechanism, which can easily cause damage to internal electronic components. Furthermore, the switch status of the existing satellite communicator is not clearly displayed, the user cannot easily determine the switch status of the satellite communicator, and it is difficult to know the correct operating status of the device.

### SUMMARY

The disclosure provides a communication device that can switch between a startup mode and a shutdown mode with simple and clear operations, and allows users to clearly know the current operating status.

The communication device of the disclosure includes a device body and a knob. The device body has a through hole. The knob is rotatably installed in the through hole, and a back side of the knob is exposed to the device body through the through hole and has a positioning hole. The knob is adapted to rotate to a first state with respect to the device body so that the communication device is in a startup mode, and the knob is adapted to rotate to a second state with respect to the device body so that the communication device is in a shutdown mode.

In an embodiment of the disclosure, the knob is adapted to be positioned on a handheld electronic device by the positioning hole. When the knob is positioned on the handheld electronic device, the device body is adapted to rotate with respect to the handheld electronic device so that the knob is switched between the first state and the second state.

In an embodiment of the disclosure, the communication device further includes a movable bump, in which the inner wall of the through hole has an opening, and the movable bump is movably disposed in the opening. When the knob is in the first state, the knob pushes the movable bump to abut the device body to activate the device body. When the knob is in the second state, the knob releases the movable bump to reset the movable bump.

In an embodiment of the disclosure, the knob has a recess and an abutting surface. When the knob is in the first state, the abutting surface corresponds to the movable bump and pushes the movable bump to abut the device body. When the knob is in the second state, the recess corresponds to the movable bump and accommodates at least part of the movable bump. In an embodiment of the disclosure, the communication device further includes a switch

assembly, in which the switch assembly is disposed in the device body and corresponds to the movable bump. When the knob is in the first state, the movable bump triggers the switch assembly. When the knob is in the second state, the movable bump releases the switch assembly.

In an embodiment of the disclosure, the switch assembly has an elastic trigger part, the movable bump is adapted to press the elastic trigger part to trigger the switch assembly, and the movable bump is adapted to be reset by the elastic force of the elastic trigger part.

In an embodiment of the disclosure, the communication device further includes a waterproof cover, in which the waterproof cover is connected between the movable bump and the periphery of the opening.

In an embodiment of the disclosure, when the device body rotates with respect to the handheld electronic device so that the knob is switched to the second state, the device body is stacked on a back surface of the handheld electronic device, and when the device body rotates with respect to the handheld electronic device so that the knob is switched to the first state, the device body partially moves away from the back surface.

In an embodiment of the disclosure, the communication device further includes a connecting member, in which the connecting member is adapted to be joined to the handheld electronic device and has a positioning column, and the positioning column is adapted to be positioned in the positioning hole.

In an embodiment of the disclosure, the material of at least one of the connecting member and the knob includes a magnetic material, and the positioning column is adapted to be positioned in the positioning hole through the magnetic attraction between the connecting member and the knob.

In an embodiment of the disclosure, the connecting member is adapted to be joined to the handheld electronic device by means of adhesive.

In an embodiment of the disclosure, the positioning hole is a polygon, and the positioning column is a corner-shaped column corresponding to the polygon.

In an embodiment of the disclosure, the communication device further includes a hook member, in which a first end of the hook member is adapted to be joined to the device body, a second end of the hook member has a pivot, the pivot has a positioning column, and the positioning column is adapted to be positioned in the positioning hole.

In an embodiment of the disclosure, the first end of the hook member is adapted to be joined to the device body by means of screw lock.

Based on the above, the communication device of the disclosure uses the knob as a switch operating element. The user merely needs to rotate the knob with one hand to simply and clearly switch the communication device between the startup mode and the shutdown mode, thereby avoiding the consumption of precious battery power due to cumbersome switch operations. Moreover, the user can clearly know the current operating status based on the rotation state of the knob. In addition, the knob may be positioned on the handheld electronic device by the positioning hole. In this state, the device body may be rotated with respect to the handheld electronic device, and the device body can be easily and quickly switched between the startup mode and the shutdown mode.

### BRIEF DESCRIPTION OF THE DRAWINGS

FIG. 1 is a perspective view of a communication device according to an embodiment of the disclosure.

FIG. 2 shows rotation of a knob in FIG. 1.

FIG. 3 is an exploded view of the communication device in FIG. 1.

FIG. 4 and FIG. 5 are respectively partial structural perspective views of the communication device in FIG. 1 and FIG. 2.

FIG. 6 and FIG. 7 are respectively partial structural cross-sectional views of the communication device in FIG. 1 and FIG. 2.

FIG. 8 and FIG. 9 are respectively partial structural exploded views of the communication device in FIG. 1 and FIG. 2.

FIG. 10 shows the communication device in FIG. 2 joined to a handheld electronic device.

FIG. 11 and FIG. 12 are exploded views of the communication device and the handheld electronic device in FIG. 10 from different perspectives.

FIG. 13 shows the device body in FIG. 10 rotating with respect to the handheld electronic device.

FIG. 14 shows a user holding the handheld electronic device in FIG. 13.

FIG. 15 shows a hook member installed on the device body in FIG. 2.

FIG. 16 and FIG. 17 are exploded views of the communication device in FIG. 15 from different perspectives.

FIG. 18 shows that the communication device in FIG. 15 is hung on a strap through the hook member.

### DESCRIPTION OF THE EMBODIMENTS

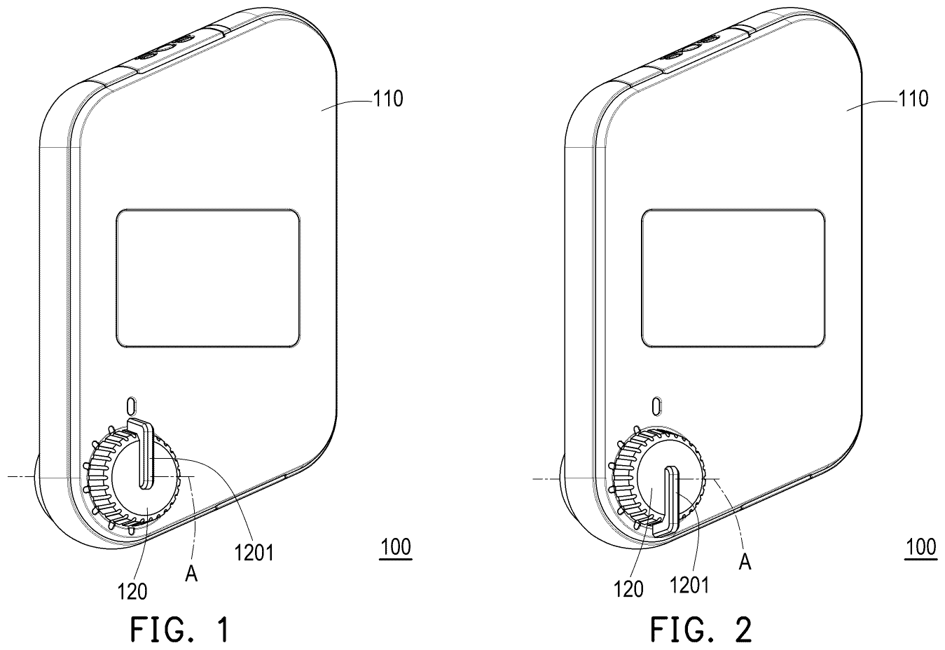

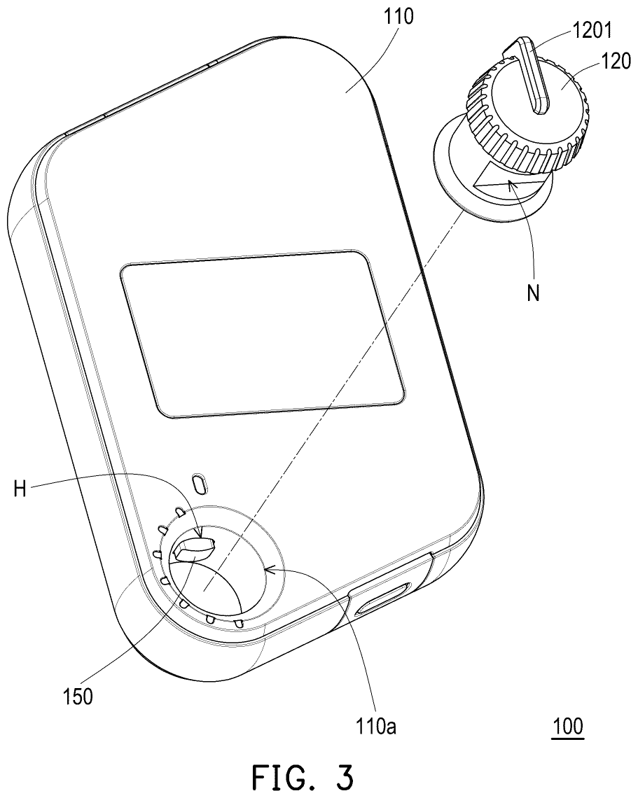

FIG. 1 is a perspective view of a communication device according to an embodiment of the disclosure. FIG. 2 shows rotation of a knob in FIG. 1. FIG. 3 is an exploded view of the communication device in FIG. 1. Referring to FIG. 1 to FIG. 3, a communication device 100 in this embodiment is, for example, a low-orbit satellite communicator, a high-orbit satellite communicator, or other types of communication devices, and the disclosure is not limited thereto. The communication device 100 includes a device body 110 and a knob 120. The device body 110 has a through hole 110a. The knob 120 is rotatably installed in the through hole 110a. The knob 120 is adapted to rotate with respect to the device body 110 to a first state shown in FIG. 1 so that the communication device 100 is in a startup mode, and the knob 120 is adapted to rotate with respect to the device body 110 to a second state shown in FIG. 2 so that the communication device 100 is in a shutdown mode.

As mentioned above, the communication device 100 of this embodiment uses the knob 120 as a switch operating element. The user merely needs to rotate the knob 120 with one hand to simply and clearly switch the communication device 100 between the startup mode and the shutdown mode, thereby avoiding the consumption of precious battery power due to cumbersome switch operations. Moreover, the user can clearly know the current operating status based on the rotation state of the knob 120. Specifically, the knob 120 has, for example, a protruding structure 1201 for the user to identify the rotation state thereof. In other embodiments, the knob 120 may have other types of markings or structures for the user to identify the rotation state thereof.

The following describes how the knob 120 in this embodiment starts up and shuts down the device body 110.

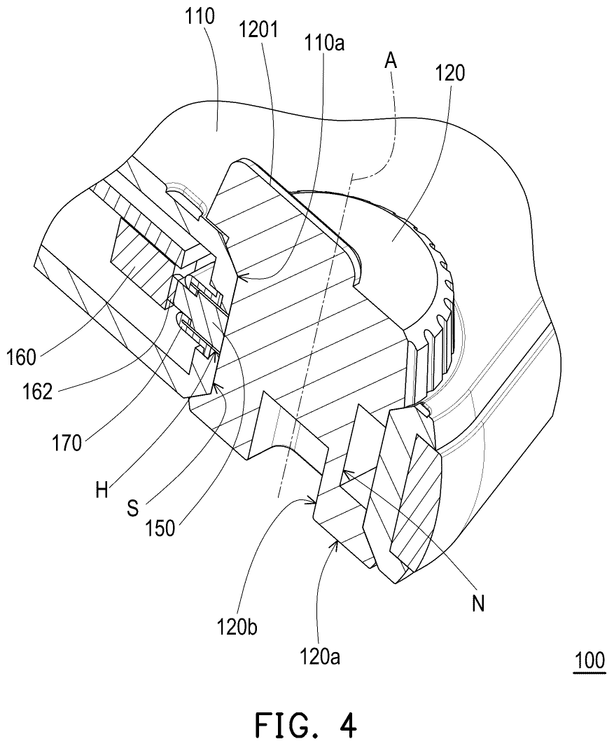

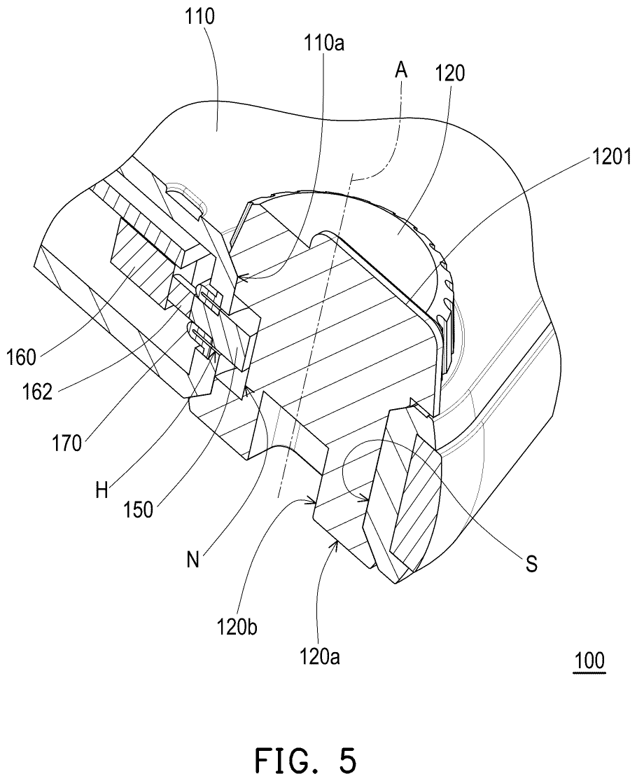

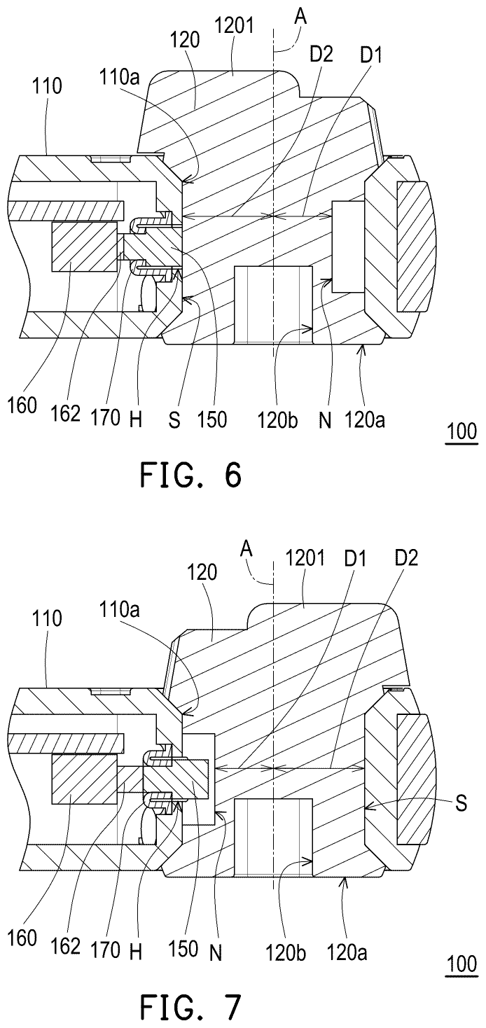

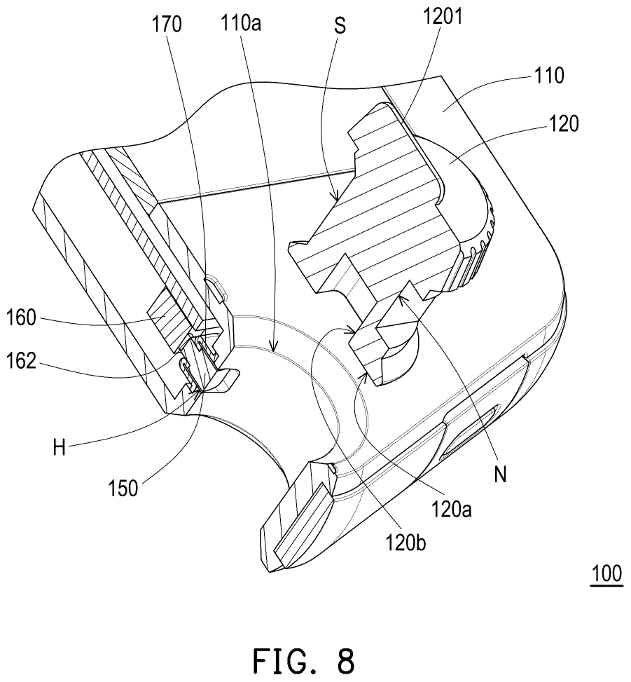

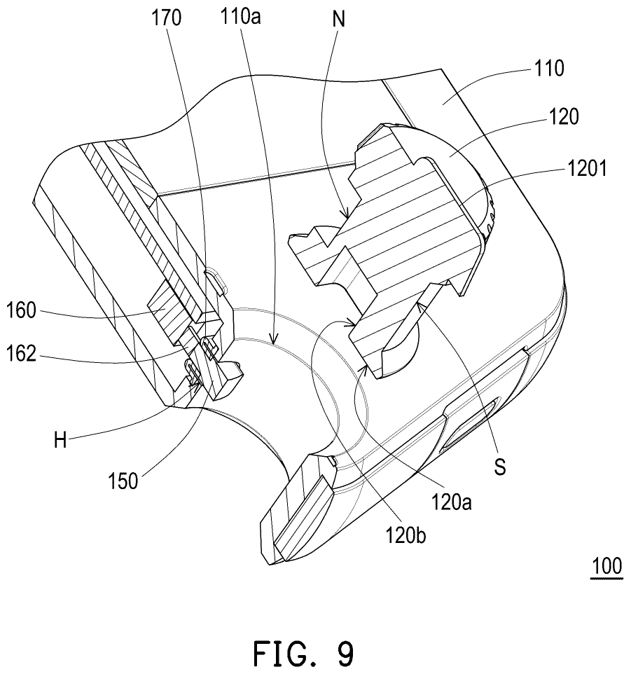

FIG. 4 and FIG. 5 are respectively partial structural perspective views of the communication device in FIG. 1 and FIG. 2. FIG. 6 and FIG. 7 are respectively partial structural cross-sectional views of the communication device in FIG. 1 and FIG. 2. FIG. 8 and FIG. 9 are respectively partial structural exploded views of the communication device in FIG. 1 and FIG. 2. Referring to FIG. 4 to FIG. 9, in this embodiment, the communication device 100 further includes a movable bump 150 and a switch assembly 160, and the inner wall of the through hole 110a has an opening H. The movable bump 150 is movably disposed in the opening H, and the switch assembly 160 is disposed in the device body 110 and corresponds to the movable bump 150. The switch assembly 160 has an elastic trigger part 162, and the elastic trigger part 162 faces the movable bump 150. In this embodiment, the elastic trigger part 162 is, for example, a spring, but the disclosure is not limited thereto.

When the knob 120 is in the first state shown in FIG. 4 and FIG. 6, the knob 120 pushes the movable bump 150 to abut the device body 110, causing the movable bump 150 to press the elastic trigger part 162 to trigger the switch assembly 160, so as to start up the device body 110. When the knob 120 is in the second state shown in FIG. 5 and FIG. 7, the knob 120 releases the movable bump 150. At this point, the movable bump 150 is reset by the elastic force of the elastic trigger part 162, and the movable bump 150 releases the switch assembly 160, so as to shut down the device body 110.

In detail, the knob 120 in this embodiment has a recess N and an abutting surface S. The knob 120 is adapted to rotate around an axis A passing through the center of a positioning hole 120b. A distance D1 (marked in FIG. 6 and FIG. 7) between the recess N and the axis A is smaller than a distance D2 (marked in the FIG. 6 and FIG. 7) between the abutting surface S and the axis A. When the knob 120 is in the first state shown in FIG. 4 and FIG. 6, the abutting surface S corresponds to the movable bump 150 and pushes the movable bump 150 to abut the device body 110. When the knob 120 is in the second state shown in FIG. 5 and FIG. 7, the recess N corresponds to the movable bump 150 and accommodates at least part of the movable bump 150. That is, the recess N provides enough space to enable the movable bump 150 to reset in a direction away from the switch assembly 160.

In addition, in this embodiment, the communication device 100 further includes a waterproof cover 170. The waterproof cover 170 is connected between the movable bump 150 and the periphery of the opening H. Accordingly, external water or other liquids can be prevented from entering the device body 110 through the opening H, thereby improving the waterproof effect of the communication device 100. The material of the waterproof cover 170 may be rubber, plastic, silicone, or other suitable elastic and/or flexible materials, so that the waterproof cover 170 may deform correspondingly as the movable bump 150 moves.

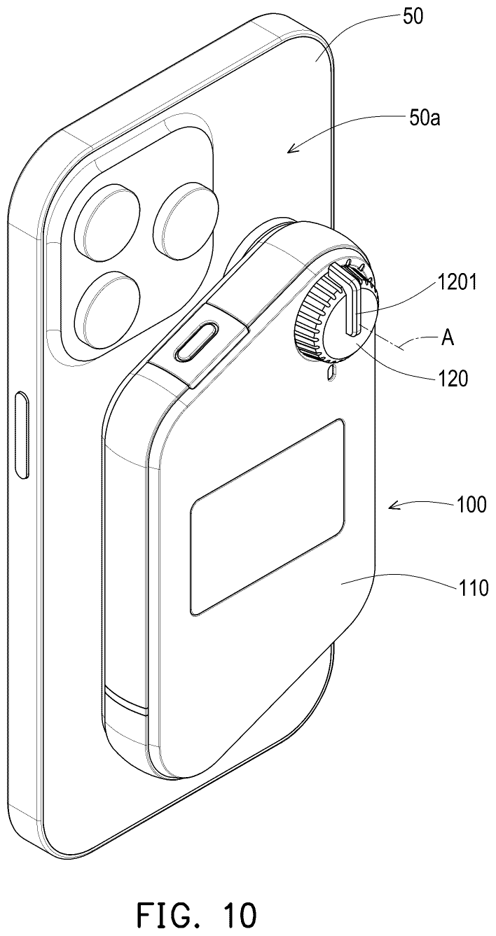

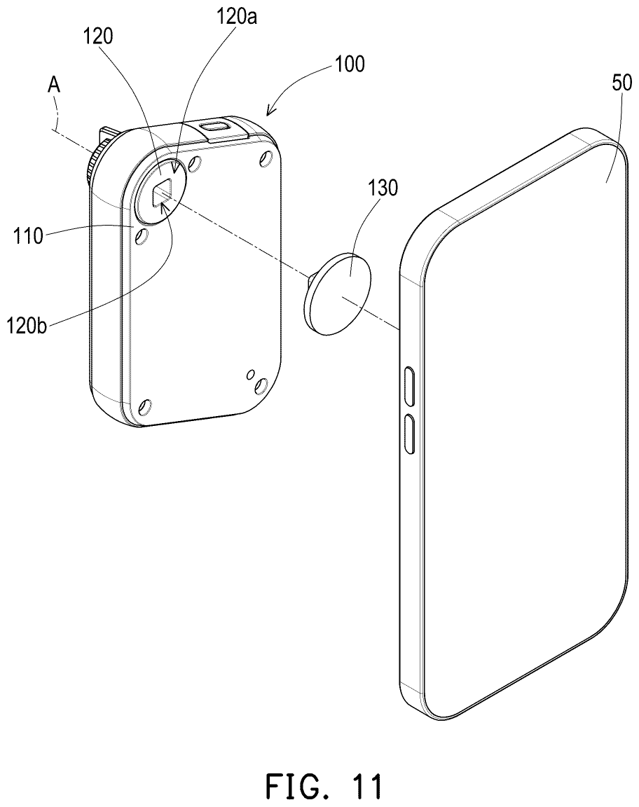

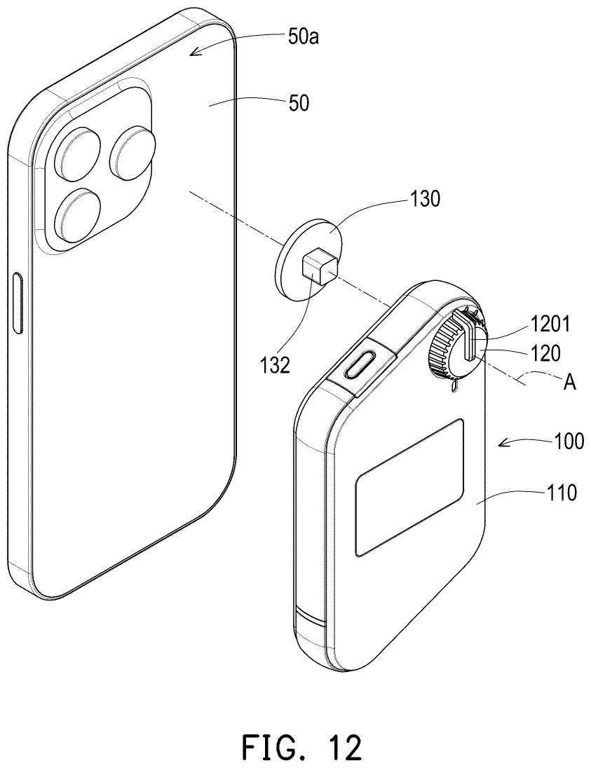

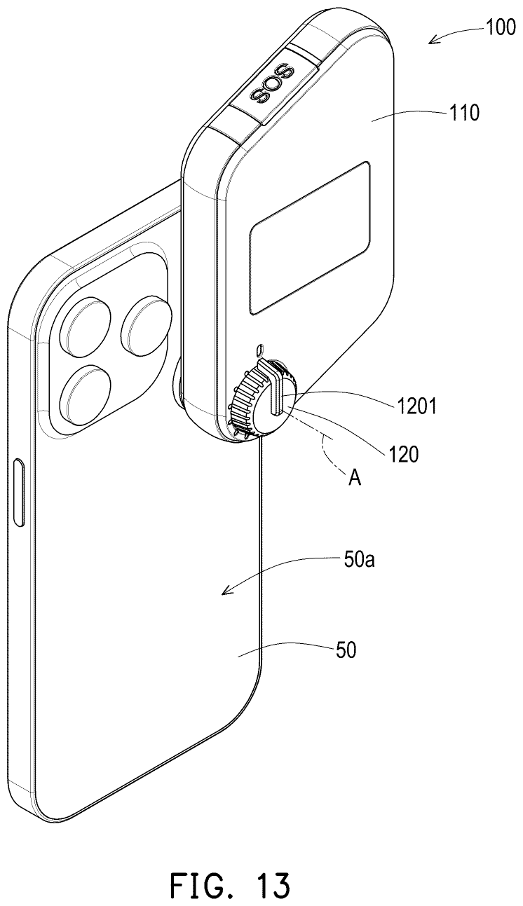

FIG. 10 shows the communication device in FIG. 2 joined to a handheld electronic device. FIG. 11 and FIG. 12 are exploded views of the communication device and the handheld electronic device in FIG. 10 from different perspectives. FIG. 13 shows the device body in FIG. 10 rotating with respect to the handheld electronic device. In this embodiment, a back side 120a (marked in FIG. 11) of the knob 120 is exposed to the device body 110 through the through hole 110a (marked in FIG. 3) of the device body 110 and has the positioning hole 120b. Moreover, the communication device 100 of this embodiment further includes a connecting member 130 (shown in FIG. 11 and FIG. 12). The connecting member 130 is adapted to be joined to a back surface 50a of a handheld electronic device 50 (such as a smartphone) through adhesive or other appropriate means. As shown in FIG. 12, the connecting member 130 has a positioning column 132. The knob 120 is adapted to be positioned through the positioning hole 120b and the positioning column 132 of the connecting member 130, so that the knob 120 is positioned on the handheld electronic device 50.

In this embodiment, the material of one of the connecting member 130 and the knob 120 may include a magnetic material, and the material of the other one of the connecting member 130 and the knob 120 may include a metal material or a magnetic material that may be magnetically attracted. Accordingly, the positioning column 132 may be firmly positioned in the positioning hole 120b through the magnetic attraction between the connecting member 130 and the knob 120.

Furthermore, the positioning hole 120b of the knob 120 is, for example, a polygon, and the positioning column 132 of the connecting member 130 is, for example, a corner-shaped column corresponding to the polygon. Accordingly, when the knob 120 is positioned through the positioning hole 120b and the positioning column 132 of the connecting member 130, the knob 120 is restricted from being able to rotate with respect to the connecting member 130 and the handheld electronic device 50. In this state, the user may rotate the device body 110 around the axis A with respect to the handheld electronic device 50 to cause relative rotation between the device body 110 and the knob 120, and easily and quickly switch the device body 110 between the startup mode and the shutdown mode.

Specifically, when the knob 120 is positioned on the handheld electronic device 50, the device body 110 is adapted to rotate with respect to the handheld electronic device 50 so that the knob 120 switches between the first state (the startup mode, corresponding to FIG. 1 and FIG. 13) and the second state (the shutdown mode, corresponding to FIG. 2 and FIG. 10) with respect to the device body 110. When the device body 110 is rotated with respect to the handheld electronic device 50 to the state in FIG. 10 so that the knob 120 is switched to the second state, the device body 110 is stacked on the back surface 50a of the handheld electronic device 50. When the device body 110 is rotated with respect to the handheld electronic device 50 to the state in FIG. 13 so that the knob 120 is switched to the first state, the device body 110 is partially moved away from the back surface 50a of the handheld electronic device 50.

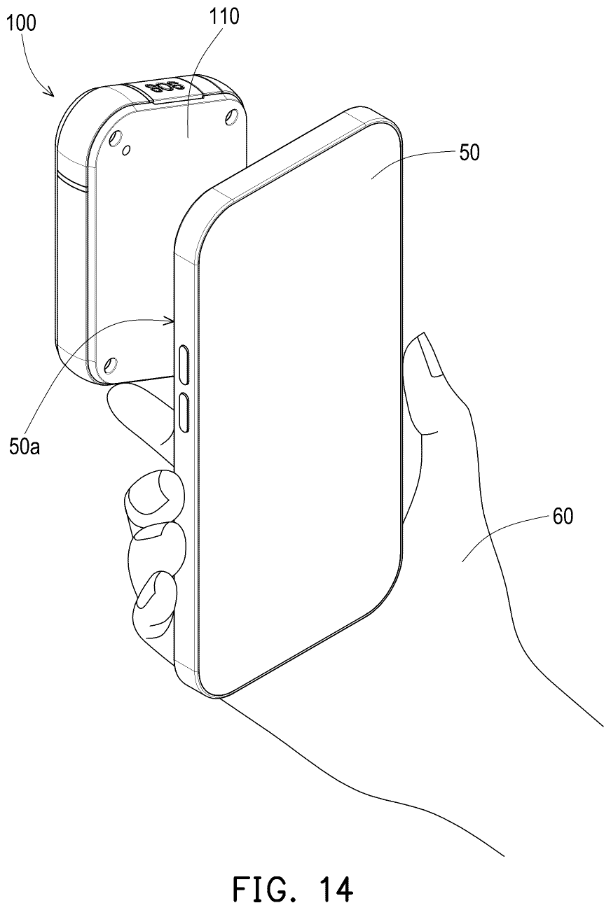

FIG. 14 shows the user holding the handheld electronic device in FIG. 13. When the communication device 100 is joined to the handheld electronic device 50 as shown in FIG. 13 and the device body 110 is partially moved away from the back surface 50a of the handheld electronic device 50, a hand 60 of the user may hold the handheld electronic device 50 as shown in FIG. 14, so as to simultaneously view the handheld electronic device 50 and the communication device 100 by holding with one hand.

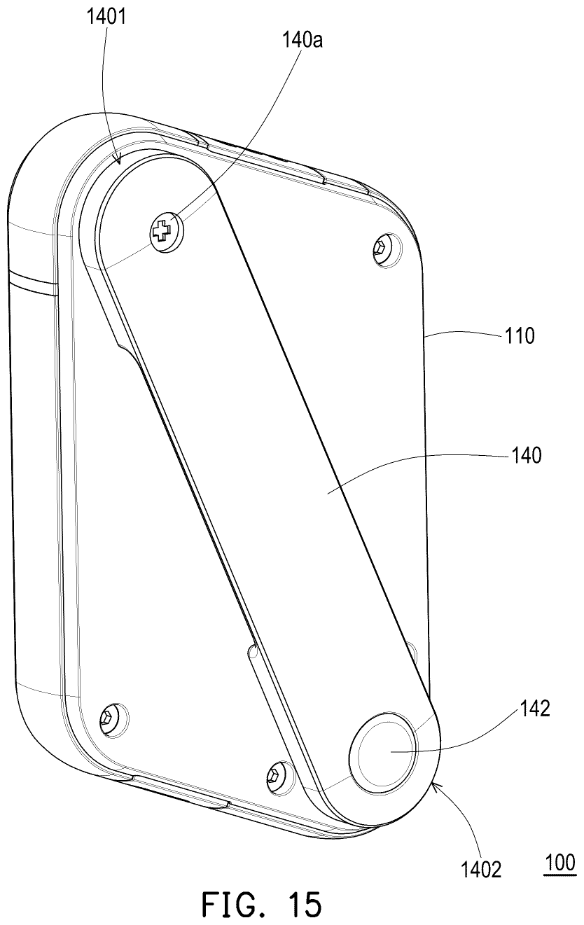

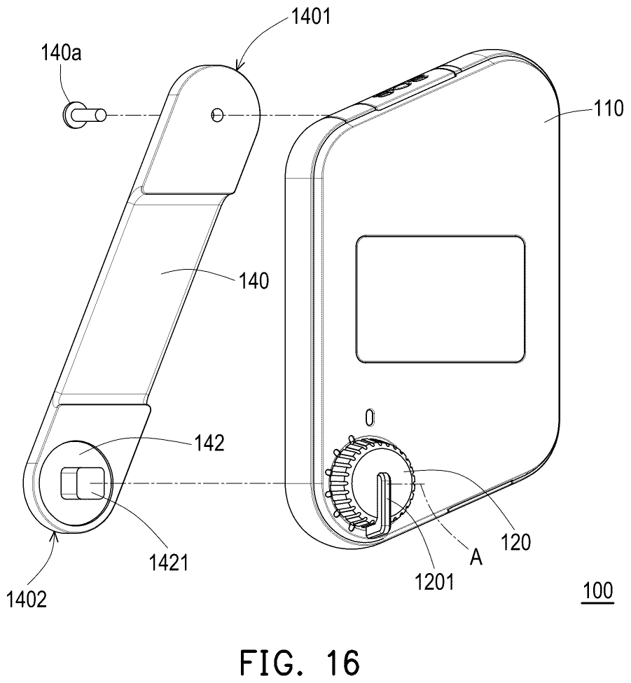

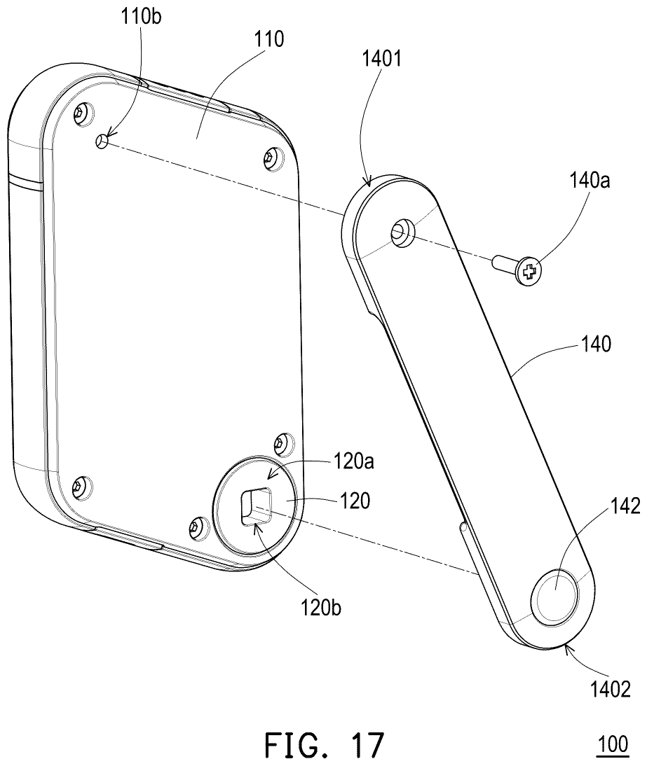

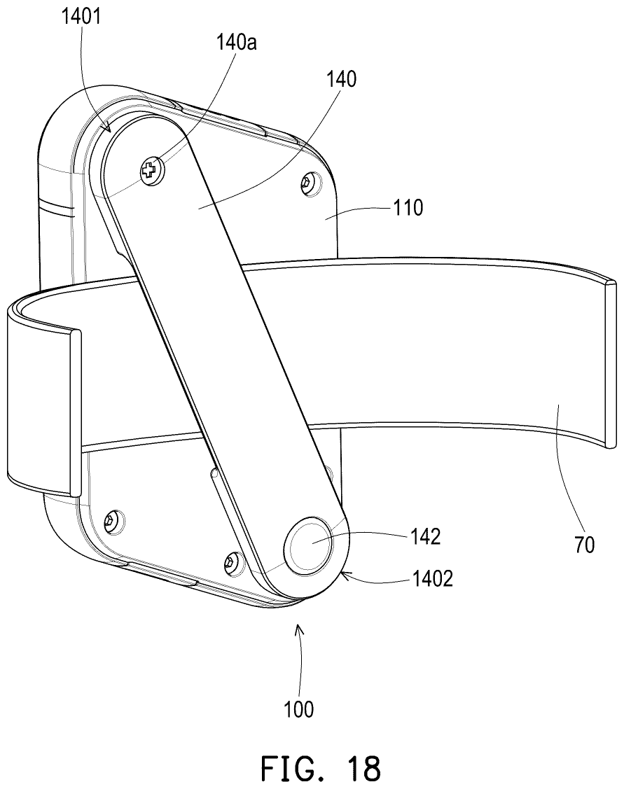

FIG. 15 shows a hook member installed on the device body in FIG. 2. FIG. 16 and FIG. 17 are exploded views of the communication device in FIG. 15 from different perspectives. Referring to FIG. 15 to FIG. 17, the communication device 100 of this embodiment further includes a hook member 140. A first end 1401 of the hook member 140 is adapted to be attached to an attachment hole 110b (such as a screw hole) of the device body 110 by an attachment member 140a (such as a screw), so that the first end 1401 of the hook member 140 is joined to the device body 110. The first end 1401 of the hook member 140 may also be joined to the device body 110 through other appropriate means, and the disclosure is not limited thereto. A second end 1402 of the hook member 140 has a rotatable pivot 142, the pivot 142 has a positioning column 1421 (shown in FIG. 16), and the positioning column 1421 is adapted to be positioned in the positioning hole 120b (shown in FIG. 17) of the knob 120.

In this embodiment, the material of one of the pivot 142 and the knob 120 may include a magnetic material, and the material of the other one of the pivot 142 and the knob 120 may include a metal material or a magnetic material that may be magnetically attracted. Accordingly, the positioning column 1421 may be firmly positioned in the positioning hole 120b through the magnetic attraction between the pivot 142 and the knob 120.

Furthermore, the positioning hole 120b of the knob 120 is, for example, a non-circular hole, the positioning column 1421 of the pivot 142 is, for example, a non-cylinder, and the shape of the positioning hole 120b corresponds to the shape of the positioning column 1421. In a state where the knob 120 is positioned through the positioning hole 120b and the positioning column 1421 of the pivot 142, when the user rotates the knob 120, the pivot 142 rotates with the knob 120.

FIG. 18 shows that the communication device in FIG. 15 is hung on a strap through the hook member. When the device body 110 is disposed with the hook member 140 as shown in FIG. 15, the user may put a strap 70 of a backpack between the device body 110 and the hook member 140 as shown in FIG. 18, so that the communication device 100 may be hung on the strap 70 of the backpack for easy portability.

In summary, the communication device of the disclosure uses the knob as the switch operating element. The user merely needs to rotate the knob with one hand to simply and clearly switch the communication device between the startup mode and the shutdown mode, thereby avoiding the consumption of precious battery power due to cumbersome switch operations. Moreover, the user can clearly know the current operating status based on the rotation state of the knob. In addition, the knob may be positioned on the handheld electronic device by the positioning hole. In this state, the device body may be rotated with respect to the handheld electronic device, and the device body can be easily and quickly switched between the startup mode and the shutdown mode.

What is claimed is:

1. A communication device, comprising:
a device body having a through hole; and
a knob rotatably installed in the through hole, wherein a back side of the knob is exposed to the device body through the through hole and has a positioning hole,
the knob is adapted to rotate to a first state with respect to the device body so that the communication device is in a startup mode, and the knob is adapted to rotate to a second state with respect to the device body so that the communication device is in a shutdown mode.

2. The communication device as claimed in claim 1, wherein the knob is adapted to be positioned on a handheld electronic device through the positioning hole, and in response to the knob being positioned on the handheld electronic device, the device body is adapted to rotate with respect to the handheld electronic device so that the knob is switched between the first state and the second state.

3. The communication device as claimed in claim 1, further comprising a movable bump, wherein an inner wall of the through hole has an opening, and the movable bump is movably disposed in the opening, in response to the knob being in the first state, the knob pushes the movable bump to abut the device body, so as to start up the device body, and in response to the knob being in the second state, the knob releases the movable bump, so that the movable bump is reset.

4. The communication device as claimed in claim 3, wherein the knob has a recess and an abutting surface, in response to the knob being in the first state, the abutting surface corresponds to the movable bump and pushes the movable bump to abut the device body, and in response to the knob being in the second state, the recess corresponds to the movable bump and accommodates at least part of the movable bump.

5. The communication device as claimed in claim 3, further comprising a switch assembly, wherein the switch assembly is disposed in the device body and corresponds to the movable bump, in response to the knob being in the first state, the movable bump triggers the switch assembly, and in response to the knob being in the second state, the movable bump releases the switch assembly.

6. The communication device as claimed in claim 5, wherein the switch assembly has an elastic trigger part, the movable bump is adapted to press the elastic trigger part to trigger the switch assembly, and the movable bump is adapted to be reset by an elastic force of the elastic trigger part.

7. The communication device as claimed in claim 3, further comprising a waterproof cover, wherein the waterproof cover is connected between the movable bump and a periphery of the opening.

8. The communication device as claimed in claim 2, wherein in response to the device body rotating with respect to the handheld electronic device so that the knob is switched to the second state, the device body is stacked on a back surface of the handheld electronic device, and in response to the device body rotating with respect to the handheld electronic device so that the knob is switched to the first state, the device body partially moves away from the back surface.

9. The communication device as claimed in claim 2, further comprising a connecting member, wherein the connecting member is adapted to be joined to the handheld electronic device and has a positioning column, and the positioning column is adapted to be positioned in the positioning hole.

10. The communication device as claimed in claim 9, wherein a material of at least one of the connecting member and the knob includes a magnetic material, and the positioning column is adapted to be positioned in the positioning hole through magnetic attraction between the connecting member and the knob.

11. The communication device as claimed in claim 9, wherein the connecting member is adapted to be joined to the handheld electronic device by means of adhesive.

12. The communication device as claimed in claim 9, wherein the positioning hole is a polygon and the positioning column is a corner-shaped column corresponding to the polygon.

13. The communication device as claimed in claim 1, further comprising a hook member, wherein a first end of the hook member is adapted to be joined to the device body, a second end of the hook member has a pivot, the pivot has a positioning column, and the positioning column is adapted to be positioned in the positioning hole.

14. The communication device as claimed in claim 13, wherein the first end of the hook member is adapted to be joined to the device body by means of screw lock.
